(19) United States
(12) Patent Application Publication
(10) Pub. No.: US 2007/0158259 A1
(43) Pub. Date: Jul. 12, 2007

(54) Interlayer support

(76) Inventor: Peter Ludwig, Raubling (DE)

Correspondence Address: PERRET DOISE;A PROFESSIONAL LAW CORPORATION, P.O. DRAWER 3408, LAFAYETTE, LA, 70502-3408, US

(21) Appl. No.: 10/588,134

(22) PCT Filed: Feb. 1, 2005
(86) PCT No.: PCT/DE05/00148

§ 371 Date: Jul. 31, 2006

(30) Foreign Application Priority Data
Feb. 6, 2004 (DE) 20 2004 001 802.0
Jul. 22, 2004 (DE) 102004035697.1

(51) Int. Cl. B01D 33/00

(52) U.S. Cl. 210/325

(57) ABSTRACT

The invention relates to an interlayer support suitable for depositing a self-adhesive material with a layer of self-adhesive (20). Said interlayer support comprises a relief structure (22) with raised webs forming substantially complementary channels in the self-adhesive (20) layer, by means of which the air trapped during adhesion can escape. The relief structure (22) is an irregular polygonal structure with stochastically formed and distributed polygons having between four and seven angles and connected by their angles.

The invention relates to an interlayer support comprising a laminar substrate and an interlayer applied thereon The interlayer support is suitable for depositing a self-adhesive material provided with a layer of adhesive. Said support comprises a relief structure with raised webs forming substantially complementary channels in the layer of adhesive, through which air trapped during adhesion can escape.

Self-adhesive materials are well known in practice. They usually have a viewing side, which can be transparent, translucent, non-transparent (opaque), single colored or multi-colored and/or carry any type of information, and a layer of adhesive on the back side. Prior to the adhesion, the adhesive is covered with an interlayer support (release liner) To carry out the adhesion, the interlayer support is peeled off and the self-adhesive material with the layer of adhesive is fixed on the base surface to be bonded.

Especially in the case of large area, air impermeable self-adhesive materials, e.g. having a plastic film on or behind the viewing side, a problem is created in that air is trapped during the adhesion, forming bubbles and preventing an adhesive contact with the base surface over the entire surface area. The external appearance of flexible self-adhesive materials can be influenced by the air bubbles or undesirable holes and/or creases, which are generated in the attempt to straighten out the air bubbles.

To prevent air bubbles during the adhesion, it is known to provide the interlayer support (release liner) of a self-adhesive material with a relief structure comprising raised webs, which, subsequent to the peeling off of the interlayer support, leave behind channels, at least temporarily, through which the trapped air can escape.

For this purpose, in EP 0 951 518 B1 an interlayer support comprised of polyethylene coated paper and a silicone interlayer is embossed in an additional process step (see examples 43 to 49 in EP 0 951 518 B1). The relief structure has two sets of straight, equidistant, parallel running webs, which cross each other and form a regular pattern of rhombuses comprising rhombuses having the same shape and size.

It is the object of the invention to provide an interlayer support of the initially described type comprising a relief structure by means of which the air trapped during adhesion can better escape.

In the interlayer support achieving this object, the relief structure is an irregular polygonal structure comprising stochastically formed and distributed polygons having between four and seven angles and connected by their angles.

In a preferred embodiment, the relief structure comprises webs having a width of from 50 μm to 200 μm and a height of from 5 μm to 40 μm.

In a preferred embodiment, each one polygon covers an area of from 0.5 mm² to 3 mm².

In a preferred embodiment, a substrate preferably comprised of paper or plastic film is coated with plastic and the relief structure is provided in the plastic coating. In particular, the relief structure can be obtained by cooling a plastic coating extruded onto the substrate on a cooling cylinder having recesses which are complementary to the webs. The interlayer is applied by homogeneously siliconizing the substrate over the entire surface in the conventional manner.

Interlayer supports comprising a substrate made of plastic coated paper only have a share of approx. 10% in the overall interlayer support market because of relatively high production costs. For the majority of the interlayer supports, the substrate is comprised of coated paper, silicone base paper (highly compacted, supercalendered “glassine paper”) and plastic films.

One aspect of the invention is to make a substrate of coated paper suitable for an interlayer support, which forms channels in the layer of adhesive of a self-adhesive material deposited therewith, said channels allowing air trapped during adhesion to escape.

A first solution for this aspect is to provide the relief structure of the substrate entirely or in part by means of the coating of the paper itself. For this, the cast coating process is used, by which a base paper is conventionally finished with a clay coating or pigment coating in order to achieve a smooth and/or glossy surface. The cast coating process is a combined coating and drying process, in which the freshly coated paper is passed over a drying cylinder. To produce the desired relief structure, the drying cylinder may be engraved or etched with a complementary structure.

A second solution is to provide the relief structure of the substrate completely or partially by way of an imprint on the paper coating. This measure can be combined with the formation of the relief structure by the coating itself, as described above.

It is generally known that the printability of paper and its capacity to be siliconized is improved by means of coating. Also in this case, the prior art for printing relief structures is extensive, for example for embossed printing or for decorative purposes (e.g. wallpapers, release paper for producing artificial leather). The printing inks used are partly thermally swelling and partly highly viscous and rapidly UV-curing. This prior art does not yield much for the invention. On the one hand, the conventionally imprinted relief structures are very crude and, on the other hand, the printing inks used are, at most, only compatible to a limited extent with the interlayer support to be applied on the substrate. Special silicone systems are employed for the interlayer support, which can be thermal or radiation curing, are applied as emulsion or solution with different solvents or as solvent-free solid silicone and are only too easily inhibited in their separating action by foreign chemicals, especially in the sense of an undesirable reduced chemical curing and adhesion of the silicone (“smear”, “rub-off”, “peel-off”). Thermal influences and long term effects must thereby be taken into account. The realization of a relief structure imprinted on coated paper for the purpose of the present invention required extensive research for silicone compatible printing inks and suitable printing technologies.

In a preferred embodiment, the substrate comprises plastic coated paper, plastic film or plastic coated plastic film. The substrate can be dispersion coated, laminated or extrusion coated with the plastic coating. The relief structure is provided by way of an imprint on the plastic.

In a further embodiment, the substrate of the interlayer support, which is comprised of paper or plastic film, is printed with the interlayer in order to apply said interlayer on the substrate over the entire surface and with the inventive relief structure. The printing technology enables the interlayer to be structured accordingly. Printing material comprises modified silicone systems or printing inks modified with silicone.

Subsequent to all the above, on the one hand, the relief structure according to the invention can be applied on the substrate of the interlayer support and the substrate homogeneously siliconized in the conventional manner and, on the other hand, an interlayer comprising the relief structure can be imprinted on a homogeneous substrate.

The invention relates in equal measure to the interlayer supports (release liners) obtained in this way and self-adhesive materials deposited therewith.

The invention will be explained in more detail hereinafter with reference to exemplary embodiments illustrated in the drawing, wherein:

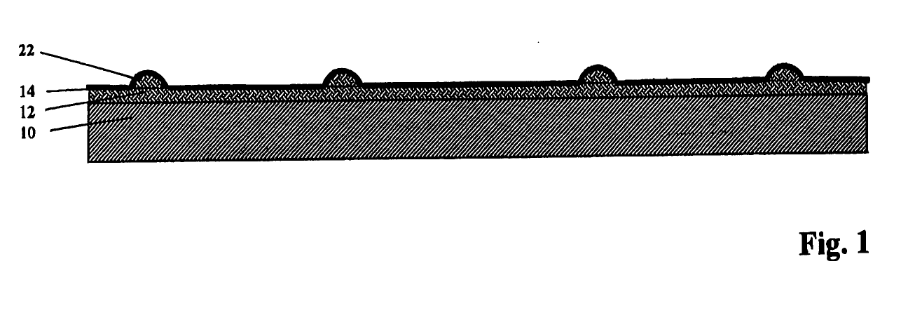

FIG. 1 is the schematic side view of an interlayer support comprising a substrate of coated paper and a raised relief structure, which is provided by the coating of the paper;

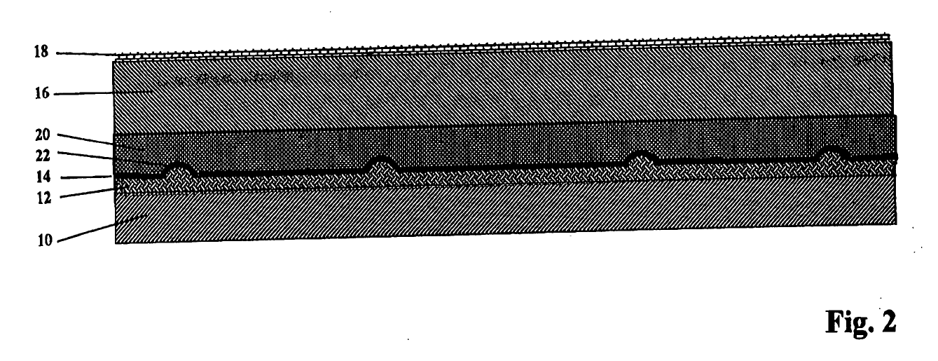

FIG. 2 is the schematic side view of a self-adhesive material comprising the interlayer support according to FIG. 1;

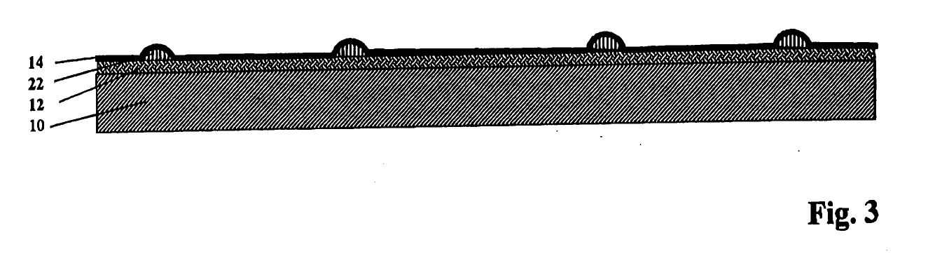

FIG. 3 is the schematic side view of an interlayer support comprising a substrate of coated paper and a raised relief structure imprinted thereon;

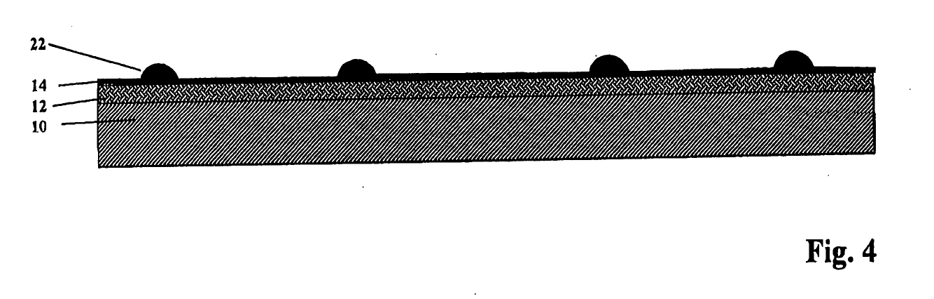

FIG. 4 is the schematic side view of an interlayer support comprising a substrate of coated paper and an interlayer imprinted thereon, which comprises a relief structure; and

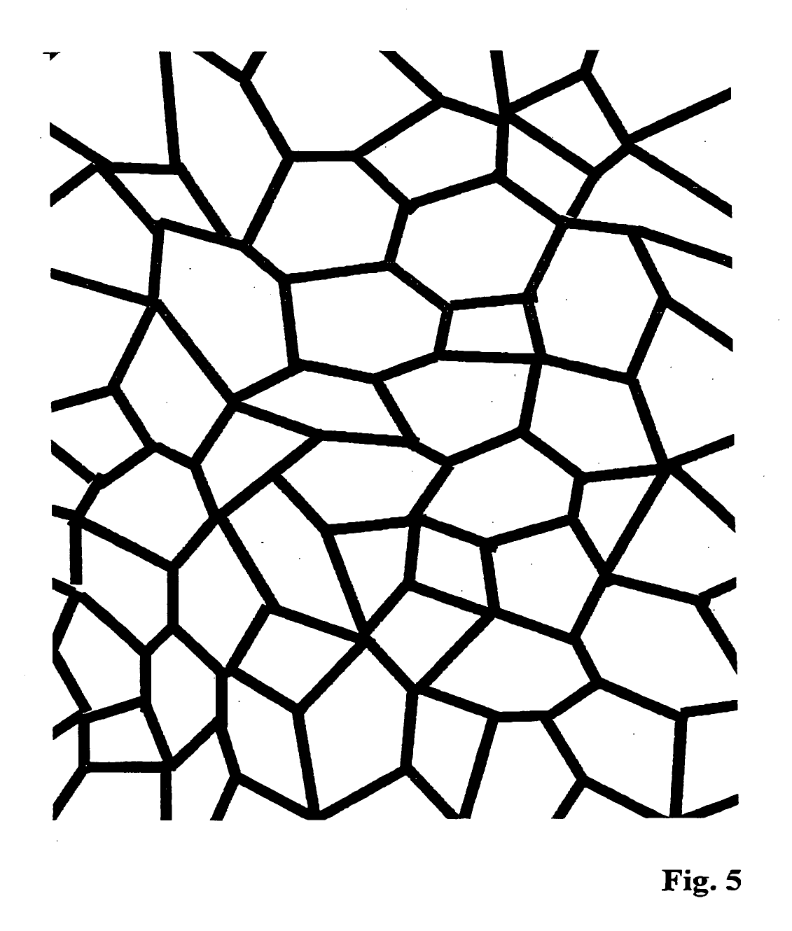

FIG. 5 is a plan view on the relief structure, which is irregular polygonal comprising a stochastically varying form and distribution of polygons having between four to seven angles and being connected by their angles.

The interlayer support shown in FIG. 1 has a laminar substrate 10 of coated paper, the coating 12 of which provides a raised a relief structure 22. An interlayer 14 made of silicone lies over the entire surface of the substrate 10.

FIG. 2 shows a self-adhesive material in which a print substrate 16 having an imprint 18 on the viewing side is coated with adhesive on the back side and the layer 20 of adhesive is deposited with the mentioned interlayer support.

In the same manner, FIG. 1 and FIG. 2 represent an interlayer support, which has a laminar substrate 10 of paper or plastic film, onto which there is extruded a plastic coating 12 comprising a raised relief structure.

The interlayer support shown in FIG. 3 has a laminar substrate 10 of coated paper, on the planar coating 12 covering the entire surface of which there is imprinted a relief structure 22. Thereover is an interlayer 14 of silicone covering the entire surface.

In the same manner, FIG. 3 represents an interlayer support, which has a laminar substrate 10 of paper or plastic film. The substrate is dispersion coated, laminated or extrusion coated over the entire surface with a laminar plastic layer 12. A relief structure 22 is imprinted on the plastic layer 12.

The interlayer support shown in FIG. 4 has a laminar substrate 10 of coated paper, on the planar coating 12 covering the entire surface of which there is imprinted an interlayer 14 of silicone, which has a relief structure 22.

In the same manner, FIG. 4 represents an interlayer support, which has a laminar substrate 10 of paper or plastic film. The substrate 10 is dispersion coated, laminated or extrusion coated over the entire surface with a planar plastic layer 12. An interlayer 14 of silicone comprising a relief structure 22 is imprinted on the plastic layer 12.

FIG. 5 shows the relief structure.

List of Reference Signs

10 Substrate
12 Coating or plastic coating
14 Interlayer
16 Print substrate
18 Imprint
20 Layer of adhesive
22 Relief structure

1. An interlayer support comprising a laminar substrate and an interlayer applied thereon, which is suitable for depositing a self-adhesive material provided with a layer of adhesive and comprises a relief structure with raised webs forming substantially complementary channels in the layer of adhesive, through which air trapped during adhesion can escape, wherein the relief structure is an irregular polygonal structure comprising stochastically formed and distributed polygons having between four and seven angles and connected by their angles.

2. The interlayer support according to claim 1, wherein the relief structure comprises webs having a width of from 50 um to 200 um and a height of from 5 um to 40 um.

3. The interlayer support according to claim 1 wherein each one polygon covers an area of from 0.5 mm² to 3 mm².

4. The interlayer support according to claim 1 wherein the substrate (10) is coated with plastic and the relief structure (12) is provided in the plastic coating.

5. The interlayer support according to claim 4, wherein the relief structure is obtained by cooling a plastic coating extruded onto the substrate on a cooling cylinder having recesses which are complementary to the webs

6. The interlayer support according to claim 1 wherein the substrate comprises paper.

7. The interlayer support according to claim 1 wherein the substrate comprises plastic film.

8. The interlayer support according to claim 1 wherein the substrate comprises coated paper.

9. The interlayer support according to claim 8, wherein the relief structure is at least partly provided by the coating of the paper.

10. The interlayer support according to claim 11 wherein the relief structure is at least partly provided by an imprint on the coating of the paper.

11. The interlayer support according to claim 1 wherein the substrate comprises plastic coated paper, plastic film or plastic coated plastic film, and that relief structure is provided by an imprint on the plastic.

12. The interlayer support according to claim 1 wherein the interlayer is imprinted on the substrate with the relief structure covering the entire surface.

13. A self-adhesive material comprising an interlayer support according to claim 1.
